(19) United States
(12) Patent Application Publication
(10) Pub. No.: US 2005/0024355 A1
(43) Pub. Date: Feb. 3, 2005

(54) Selecting items displayed on respective areas on a screen

(76) Inventor: Atsuko Yagi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/900,093

(22) Filed: Jul. 28, 2004

(30) Foreign Application Priority Data
Jul. 29, 2003 (JP) 2003-203080
Jun. 25, 2004 (JP) 2004-188076

(51) Int. Cl. G09G 5/00

(52) U.S. Cl. 345/204

(57) ABSTRACT

An apparatus for generating display data, which is supplied to a display apparatus connected through a network and causes a screen comprised of a plurality of divided areas to be displayed, includes an edit-screen providing unit configured to provide the display apparatus with edit-screen data that causes an edit screen to be displayed on which display components are selected for presentation in the respective divided areas, and a display-data generating unit configured to generate the display data that causes display components selected on the edit screen to be displayed in the respective divided areas.

### BACKGROUND OF THE INVENTION

1. Field of the Invention

The present invention generally relates to display-data generating apparatuses, display apparatuses, display-data generating systems, display-data generating apparatus controlling methods, display-data generating programs, memory media, electronic apparatuses, and electronic apparatus controlling methods, and particularly relates to a display-data generating apparatus, a display apparatus, a display-data generating system, a display-data generating apparatus controlling method, a display-data generating program, a memory medium, an electronic apparatus, and an electronic apparatus controlling method for use in displaying data on the screen comprised of a plurality of divided areas.

2. Description of the Related Art

Owing to the recent development of Web technology, Internet users readily access information provided at various sites located around the world by use of universally applicable Web browsers. In recent years, the amount of available information has grown to an enormous amount, making it difficult to find information that is searched for. This has given rise to an increase in the number of portal sites that serve as an entrance to the Internet. Such portal sites are now indispensable for Internet users.

In corporations, EIP (enterprise information portal) has been introduced as a means for sharing information on the intranet, allowing efficient access to desired information.

Whether it is a portal site on the Internet or a portal site by the EIP, the Web page (portal page) provided by such a site is generally divided into a plurality of display areas, each of which presents frequently accessed information. This makes it possible to look through a plurality of information items at once on a single display. Such convenience may be one of the reasons why portal sites are popular.

Each user needs different information. Because of this, information presented in one of the areas of an existing portal page may be unnecessary, and a use may want information that is personally more important to him/her to be presented instead of such unnecessary information.

Accordingly, there is a need for a display-data generating apparatus, a display apparatus, a display-data generating system, a display-data generating apparatus controlling method, a display-data generating program, a memory medium, an electronic apparatus, and an electronic apparatus controlling method that allow easy setting to be made over a network with respect to information presented in a plurality of divided areas on the screen that is provided through the network.

### SUMMARY OF THE INVENTION

It is a general object of the present invention to provide a display-data generating apparatus, a display apparatus, a display-data generating system, a display-data generating apparatus controlling method, a display-data generating program, a memory medium, an electronic apparatus, and an electronic apparatus controlling method that substantially obviate one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by a display-data generating apparatus, a display apparatus, a display-data generating system, a display-data generating apparatus controlling method, a display-data generating program, a memory medium, an electronic apparatus, and an electronic apparatus controlling method particularly pointed out in the specification in such full, clear, concise, and exact terms as to enable a person having ordinary skill in the art to practice the invention.

To achieve these and other advantages in accordance with the purpose of the invention, the invention provides an apparatus for generating display data, which is supplied to a display apparatus connected through a network and causes a screen comprised of a plurality of divided areas to be displayed. The apparatus includes an edit-screen providing unit configured to provide the display apparatus with edit-screen data that causes an edit screen to be displayed on which display components are selected for presentation in the respective divided areas, and a display-data generating unit configured to generate the display data that causes display components selected on the edit screen to be displayed in the respective divided areas.

The display-data generating apparatus as described above allows the display components displayed in the respective divided areas to be easily selected on the edit screen displayed on the display apparatus connected through the network.

According to another aspect of the invention, an electronic apparatus includes an operation panel configured to display a divided screen comprised of a plurality of divided areas, an edit-screen displaying unit configured to cause the operation panel to display an edit screen on which display components are selected for presentation in the respective divided areas, and a divided-screen generating unit configured to generate the divided screen on which display components selected on the edit screen are displayed in the respective divided areas.

The electronic apparatus as described above allows the display components displayed in the respective divided areas of the divided page on the operation panel to be easily selected on the edit screen.

Further, the present invention provides a display apparatus for displaying the edit page transmitted from the display-data generating apparatus described above, a display-data generating system including the display-data generating apparatus as described above, a display-data generating apparatus controlling method, a display-data generating program causing a computer to perform the display-data generating apparatus controlling method, and a memory medium storing the display-data generating program therein.

Moreover, the present invention provides a method of controlling the electronic apparatus as described above.

According to at least one embodiment of the invention, a display-data generating apparatus, a display apparatus, a display-data generating system, a display-data generating apparatus controlling method, a display-data generating program, a memory medium, an electronic apparatus, and an electronic apparatus controlling method are provided that allow easy setting to be made over a network with respect to information presented in a plurality of divided areas on the screen that is provided through the network.

### BRIEF DESCRIPTION OF THE DRAWINGS

Other objects and further features of the present invention will be apparent from the following detailed description when read in conjunction with the accompanying drawings in which:

FIG. 1 is a block diagram showing an example of the construction of a Web system according to an embodiment of the invention;

FIG. 2 is a block diagram showing an example of the software construction of the Web system according to an embodiment of the invention;

FIG. 3 is a block diagram showing the function of a Web server according to an embodiment of the invention;

FIG. 4 is a flowchart of a process of generating a divided page performed by the Web server;

FIG. 5 is an illustrative drawing for explaining the schematic of a page-definition file;

FIG. 6 is an illustrative drawing showing an example of a definition provided in a page-definition file;

FIG. 7 is an illustrative drawing showing an example of a definition provided in a component-information file;

FIG. 8 is an illustrative drawing showing an example of a display-information template file;

FIG. 9 is an illustrative drawing showing an example of a format-information template file;

FIG. 10 is an illustrative drawing showing an example of how a divided page appears on a screen;

FIG. 11 is a sequence chart showing a process performed by the Web server when display components to be displayed in desired blocks are modified;

FIG. 12 is an illustrative drawing showing an example of an edit page;

FIG. 13 is an illustrative drawing showing an example of an updated edit page;

FIG. 14 is an illustrative drawing showing an example of the definition of an updated page-definition file;

FIG. 15 is an illustrative drawing showing an example of an updated divided page;

FIG. 16 is a sequence diagram showing a process performed by the Web server when a setting is made with respect to the display format of a document list;

FIG. 17 is an example of a document-list editing page;

FIG. 18 is an illustrative drawing showing an example of the definition of a page-definition file to which parameter information is added;

FIG. 19 is an illustrative drawing showing an example of a divided page after the setting of a document list is made for the right block;

FIG. 20 is a sequence chart showing a divided-page generating process in the case where a page-definition file is managed by a data management server; and

FIG. 21 is a block diagram showing an example of an image forming apparatus to which the Web server function according to the embodiment of the invention is applied.

### DESCRIPTION OF THE PREFERRED EMBODIMENTS

In the following, embodiments of the present invention will be described with reference to the accompanying drawings.

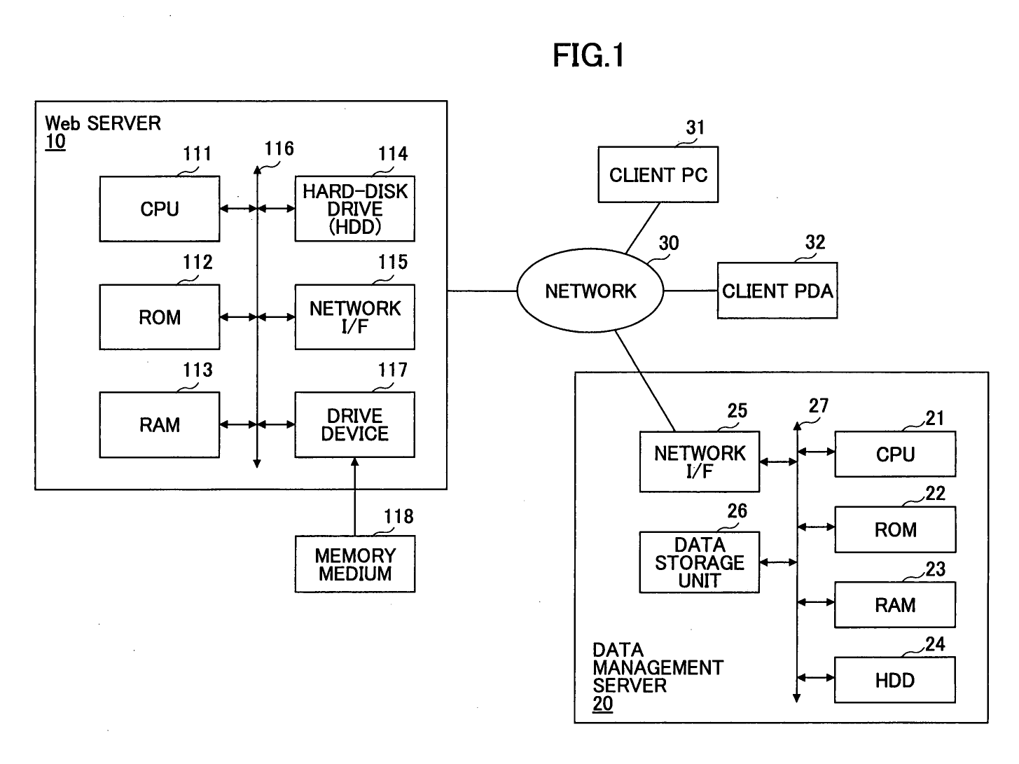

FIG. 1 is a block diagram showing an example of the construction of a Web system according to an embodiment of the invention. The Web system of FIG. 1 includes a Web server 10, a data management server 20, a client personal computer (PC) 31, and a client personal digital assistant (PDA) 32, which are connected through a network 30 (wired or wireless communication) such as a LAN, an intranet, or the Internet.

The Web server 10 responds to a request from the client personal computer 31, the client personal digital assistant 32, or the like (hereinafter collectively referred to as a terminal) by generating a Web page and transmitting the Web page to the terminal. Such Web server 10 may have a hardware construction that is implemented by use of a conventional server apparatus. That is, the Web server 10 includes a CPU 111, a ROM 112, a RAM 113, a hard-disk drive (HDD) 114, a network interface (I/F) 115, and a drive device 117, which are coupled to each other through a system bus 116.

The CPU 111 serves as a control unit for performing overall control of the Web server 10. The CPU 111 executes various control programs and application programs stored in the ROM 112 or the HDD 114, thereby controlling the operation and communication of the apparatus and performing various operations such as the acquiring and editing of data

The ROM 112 is a memory means for storing control programs of the apparatus. The RAM 113 is a memory means used as a work memory or a temporal data storage.

The HDD 114 is a memory means for storing various application programs and data. Data for implementing the present invention, which will be described later, may be stored in the HDD 114 according to need.

The network I/F 115 serves to connect the Web server 10 to the network 30.

The drive device 117 serves to read a memory medium 118 such as a CD-ROM that stores programs for implementing the functions of the invention.

An operation unit and a display unit are not shown in FIG. 1. Nonetheless, an operation unit such as a keyboard and mouse and a display unit such as a liquid crystal panel or a cathode ray tube (CRT) may be provided, thereby enabling user inputs to be entered and operation results to be displayed.

The data management server 20 responds to a request from the Web server 10 by providing the Web server 10 with information, which is to be displayed on the Web page generated by the Web server 10. The data management server 20 may have a hardware construction that is implemented by use of a conventional server apparatus. That is, the data management server 20 includes a CPU 21, a ROM 22, a RAM 23, an HDD 24, and a network I/F 25, which have functions equivalent to those of the corresponding units provided in the Web server 10. The data management server 20 further includes a data storage unit 26 serving as a nonvolatile memory means for storing various data. All the above-mentioned units are connected through a system bus 27. The HDD 24 may serve to provide the function of the data storage unit 26.

The client personal computer 31 and the client personal digital assistant 32 are conventional. These are provided with at least a function to communicate with another apparatus through the network 30 and a browser function to receive a Web page and display the received Web page.

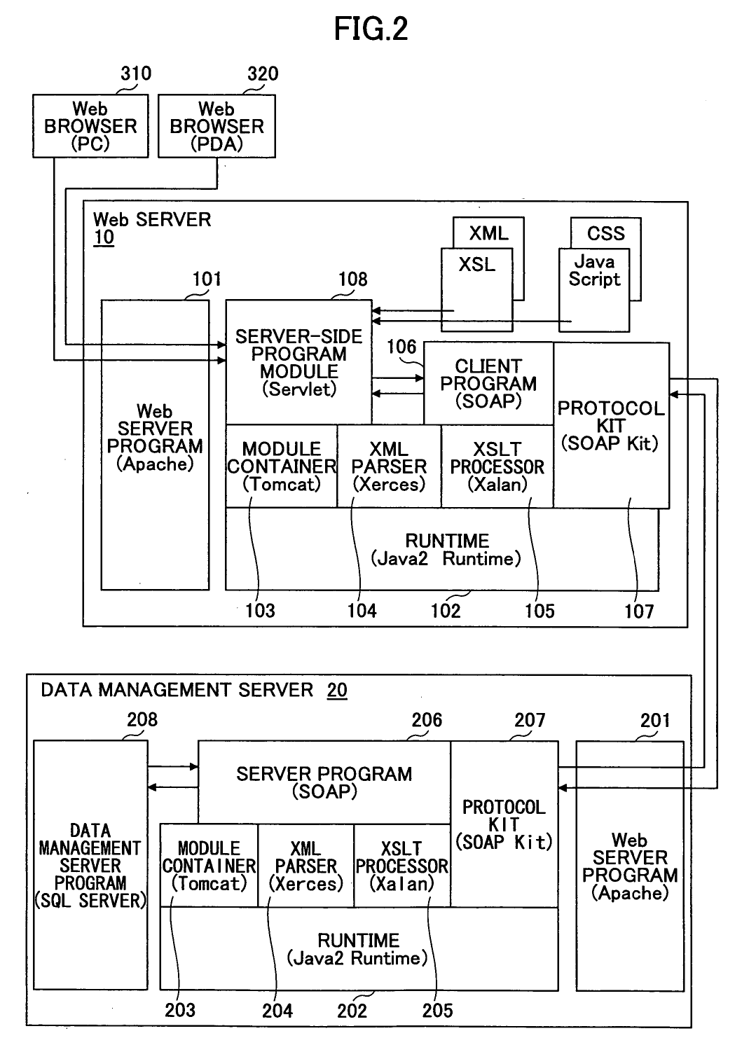

In the following, a description will be given of the software configuration of the Web system described above. FIG. 2 is a block diagram showing an example of the software construction of the Web system according to an embodiment of the invention.

As shown in FIG. 2, the Web server 10 includes a Web server program 101, a runtime 102, a module container 103, an XML parser 104, an XSLT processor 105, a client program 106, a protocol kit 107, and a server-side program module 108. These software programs are stored in the HDD 114 or the ROM 112, and are retrieved by the CPU 111 for execution as such a need arises. These software programs may as well be acquired from an external source through the network I/F 115.

The Web server program 101 serves to transmit a file in response to a request from a client in the World-Wide-Web (WWW) system. Apache provided by Apache Software Foundation may be used for this purpose.

The runtime 102 is a software module that becomes necessary when application software is executed. For this purpose, Java 2 Runtime for executing application software created in the Java 2 program language may be used. Java 2 Runtime is available from Sun Microsystems Corporation.

The module container 103 serves to provide an environment in which the server-side program module 108 is executed. Tomcat provided by Apache Software Foundation may be used for this purpose.

The XML parser 104 lays out XML data in memory by use of a tree structure where the XML data is described as a text, thereby providing easy use for other application programs. Xerces provided by Apache Software Foundation may be used for this purpose.

The XSLT processor 105 serves to convert XML data according to XSL data. Xalan provided by Apache Software Foundation may be used for this purpose.

The client program 106 is used for requesting another apparatus such as the data management server 20 to transfer a file. For this purpose, software performing SOAP(Simple Object Access Protocol)-based communication may be used. The protocol kit 107 attends to actual communication according to such a request.

The server-side program module 108 is a module program that is executed on the Web server. Servlet created in the Java 2 language may be used for this purpose. The server-side program module 108 lets the CPU 111 function as various means, thereby achieving the processes of the invention performed on the Web server 10.

The data management server 20 includes a Web server program 201, a runtime 202, a module container 203, an XML parser 204, an XSLT processor 205, a server program 206, a protocol kit 207, and a data management server program 208. Like in the case of the Web server 10, the CPU 21 retrieves and executes these software programs as such a need arises. The functions of these software programs other than the server program 206 and the data management server program 208 are the same as those of corresponding software programs described above in connection with the Web server 10, and a description thereof will be omitted.

The server program 206 serves to transfer a relevant file in response to a file-transfer request supplied from another apparatus such as the Web server 10. For this purpose, software performing SOAP(Simple Object Access Protocol)-based communication may be used. If a software program is usable for both a client and a server, the same software program as the client program 106 may be used.

The data management server program 208 serves to control and manage text data and the like stored in the data storage unit 26. The data management server program 208 further has a function to retrieve relevant data from the data storage unit 26 in response to a file-transfer request supplied from the server program 206. In addition to the function to retrieve a file from the data storage unit 26 as it is, the data management server program 208 may further include a function to extract data satisfying a predetermined condition from the file and a function to perform the processing of data such as the combining of a plurality of files. For this purpose, an SQL server program conforming to the SQL (Structured Query Language) may be used. The use of such a program makes it possible to avoid transferring unnecessary data to the Web server 10, thereby reducing the load on the network.

The use of the software construction as described above makes it possible to use the data management server 20 as a data management apparatus of the Web system.

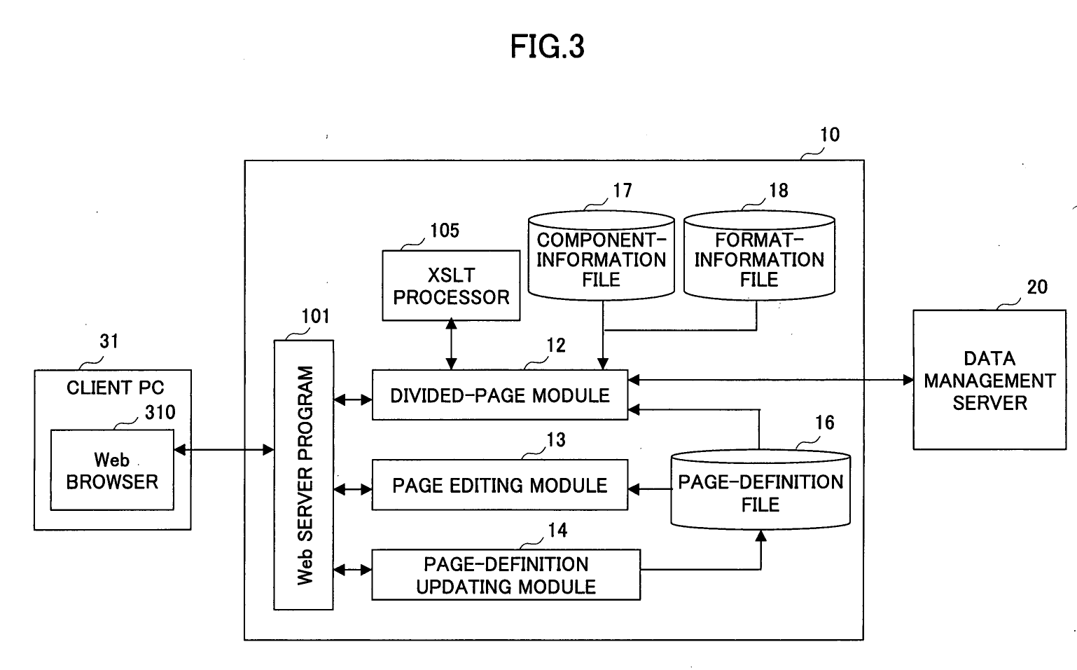

In the following, a description will be given of an example of the functional construction of the Web server 10 for the purpose of achieving the invention. FIG. 3 is a block diagram showing the function of the Web server according to an embodiment of the invention. In FIG. 3, a divided-page module 12, a page editing module 13, and a page-definition updating module 14 (these are collectively referred to as a page module) are provided as the instances of the server-side program module 108 shown in FIG. 2.

The divided-page module 12 is a server-side program module for generating a predetermined Web page in response to a request from the Web browser 310 of the client personal computer 31. In this embodiment, a Web page generated by the divided-page module 12 is referred to as a “divided page”. The divided page has its display area divided into a plurality of sub-areas (each of which will be referred to as a “block”). In each block, a corresponding predetermined display component (GUI component) is displayed, thereby achieving the displaying of a plurality of information items on a single page.

The term “display component” refers to a GUI that provides a collection of functions, e.g., a GUI for displaying a list of documents, a GUI for displaying a bookmark, or the like.

The divided-page module 12 acquires information necessary for the generation of a divided page from the data management server 20, a format-information file 18, and the like according to definitions given in a page-definition file 16 and a component-information file 17. The detail of the page-definition file 16, the component-information file 17, and the format-information file 18 will be described later.

The page editing module 13 is a server-side program module for providing an edit page to the client personal computer 31 or the like. The edit page is a Web page, provided with an interface for allowing a user to select a display component to be displayed in the individual blocks of the divided page according to the embodiment. A user of the client personal computer 31 or the like uses the Web browser 310 or the like to display an edit page, and makes a free choice as to a display component that is to be displayed in the individual blocks of the divided page.

The page-definition updating module 14 is a server-side program module that updates the page-definition file 16 for storing correspondences of the blocks of a divided page to the respective display components according to settings made on the edit page.

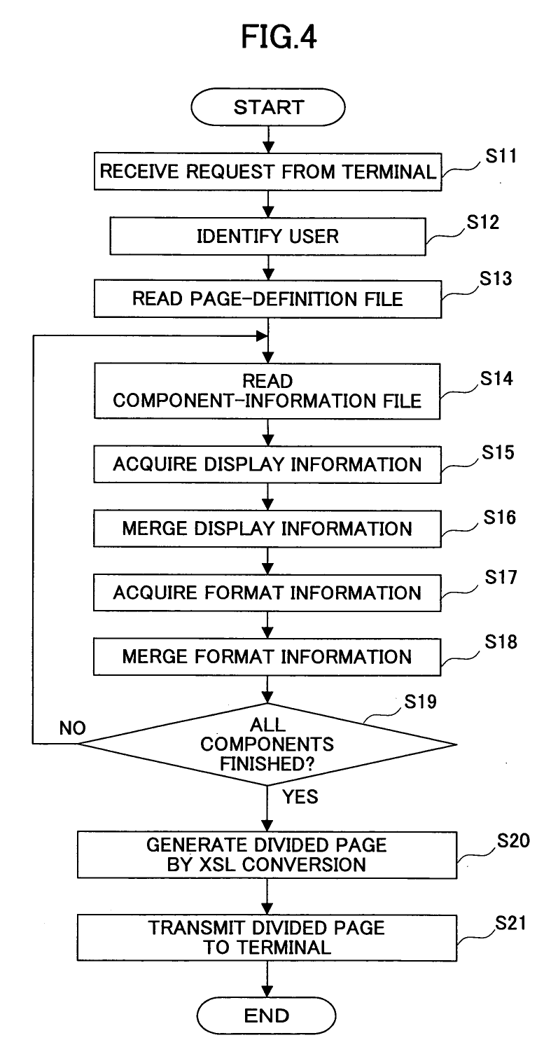

In the following, the process of the Web server 10 will be described. FIG. 4 is a flowchart of a process of generating a divided page performed by the Web server.

At step S11, the Web server program 101 of the Web server 10 receives an HTTP request from the client personal computer 31 requesting the transmission of a divided page, and calls the divided-page module 12 corresponding to the HTTP request. Here, the HTTP request is transmitted when a user enters a URL (Uniform Resource Locator) corresponding to the divided page.

At step S12 following step S11, the divided-page module 12 identifies the user of the client personal computer 31. The identifying of a user may be done by letting the user enter his/her identification information such as an ID or a password, or may be done by reading a Cookie information or the like inclusive of user identification information stored in the client personal computer 31 in advance.

At step S13 following step S12, the divided-page module 12 reads, from the page-definition file 16, information (page-definition information) corresponding to the user requesting the transmission of a divided page (hereinafter referred to as a current user) where the page-definition file 16 contains such information for a plurality of users on a user-specific basis.

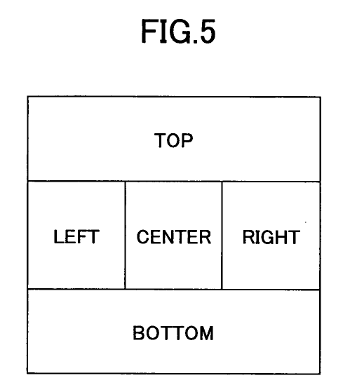

FIG. 5 is an illustrative drawing for explaining the schematic of the page-definition file. In FIG. 5, the rectangle that is divided into a plurality of areas represents a single divided page. The single divided page is divided into a plurality of blocks (a top block, a left block, a center block, a right block, and a bottom block) as shown in FIG. 5, and the page-definition file 16 stores correspondences of the individual blocks to display components to be displayed in the respective blocks.

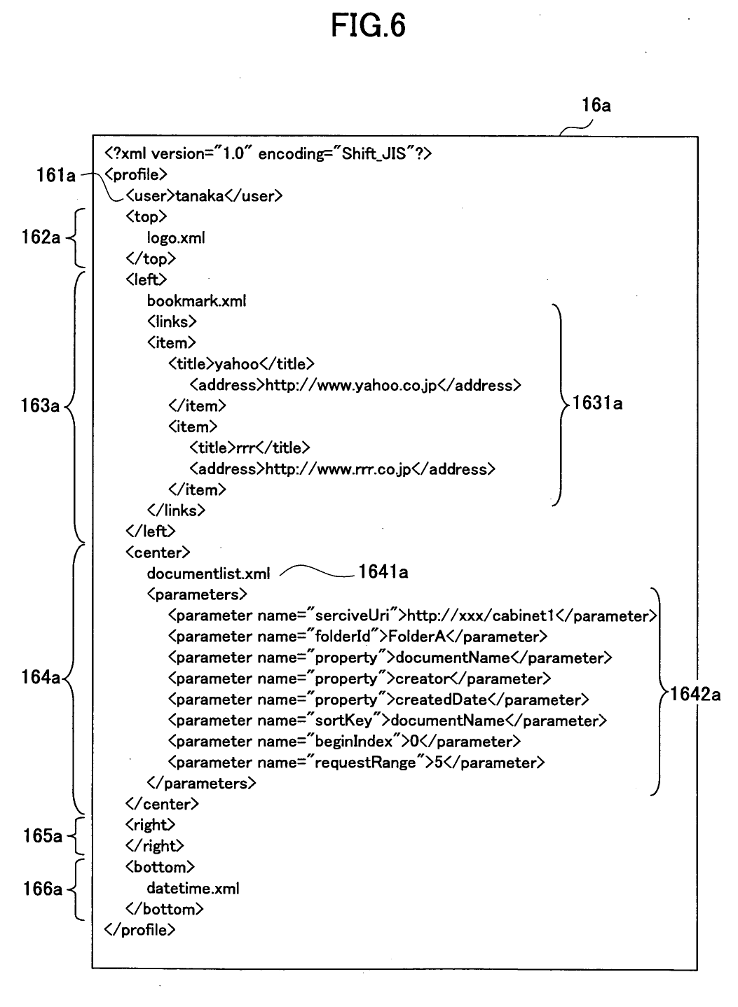

FIG. 6 is an illustrative drawing showing an example of a definition provided in a page-definition file. As shown in FIG. 6, the page-definition file 16 according to the present embodiment provides a definition by a XML-format description.

In a page-definition file 16a shown in FIG. 6, a description 161a identifies a corresponding user. Namely, the description 161a indicates that the page-definition file 16a is a page-definition file for a user having the user name “tanaka”.

A description 162a provides a definition of the top block. By the same token, descriptions 163a, 164a, 165a, and 166a correspond to the left block, the center block, the right block, and the bottom block, respectively.

Each description such as the description 162a includes tags having a tag name comprised of a character string for identifying a corresponding block, and, between the tags, contains information for identifying a display component to be displayed in the corresponding block. In the description 162a, for example, <top> tags are provided for identifying the top block, and a file name “logo.xml” of the component-information file 17 is given between the <top> tags as information for identifying a display component to be displayed in the top block.

The component-information file 17 contains a definition that provides information for specifying the display contents of a display component (the detail of which will be described later), and is provided as a single file separately for each type of a display component. Examples of such files include a component-information file (documentlist.xml) corresponding to a display component for presenting a list of documents managed by the data management server 20 in a table format (hereinafter referred to as a document-list component), a component-information file (bookmark.xml) corresponding to a display component for presenting a bookmark (hereinafter referred to as a bookmark component), a component-information file (calendar.xml) corresponding to a display component for presenting the date and time (hereinafter referred to as a calendar component), etc.

A description 1631a placed between the <links> tags in the description 163a and a description 1642a placed between the <parameters> tags in the description 164a are parameter information for identifying information to be displayed in the respective blocks, the detail of which will later be described.

The definition of the right block (i.e., the description 165a) contains no file name of the component-information file 17. This indicates that no display component is arranged in the right block.

At steps S14 through S19 following step S13, the procedure is performed independently for respective blocks defined in the page-definition file 16. At step S14, the divided-page module 12 reads the component-information file 17 corresponding to a block being processed (hereinafter referred to as a current block) according to the page-definition file 16. If the current block is the center block, for example, documentlist.xml is read according to the description 1641a shown in FIG. 6.

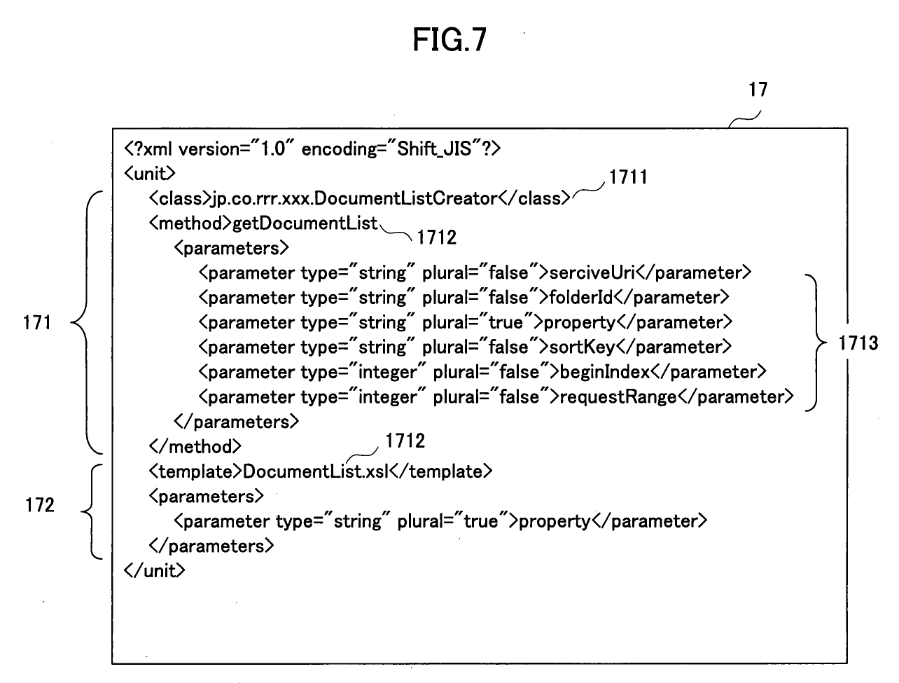

FIG. 7 is an illustrative drawing showing an example of a definition provided in the component-information file (documentlist.xml). As shown in FIG. 7, the component-information file 17 provides a definition in the XML format.

The contents of the component-information file 17 are classified largely into two definitions, i.e., a definition of a method (hereinafter referred to as a display-information acquiring method) of acquiring information (hereinafter referred to as display information) that is to be displayed in the block corresponding to the component-information file 17, and a definition of a method (hereinafter referred to as a format-information acquiring method) of acquiring data defining the format (e.g., layout) of the corresponding block. To be specific, a description 171 in FIG. 7 corresponds to the display-information acquiring method, and a description 172 corresponds to a format-information acquiring method.

The description 171 is an example of the definition of a display-information acquiring method for acquiring display-information by calling an object method implemented in the data management server 20 by use of the RPC of SOAP. Namely, a description 1711 (jp.co.rrr.xxx.DocumentListCreator) of the description 171 refers to the class name of an object that is subjected to method calling, and a description 1712 (getDocumentList) refers to the name of a method to be called. Here, the “getDocumentList” method (hereinafter referred to as a document-list acquiring method) serves to acquire a list of documents registered in a predetermined folder.

A description 1713 defines, between the <parameter> tags, the names of parameters necessary for calling the document-list acquiring method. As can be seen from the description 1713, the parameters of the document-list acquiring method include a serviceURI (the URI of a Web service (object) subjected to method calling), a folderID (the ID of a folder in which document data is searched for), property (the attribute of document data to be acquired), etc. In this manner, the description 171 defines an interface for a method of obtaining display information as the display-information acquiring method.

Values set in the respective parameters for calling the document-list acquiring method are defined as parameter information in the description 1642a (see FIG. 6) of the page-definition file 16a. As can be seen from the description 1642, the value of the parameter “seviceURI” is “http://xxx/cabinet1”, and the value of the parameter “folderID” is “FolderA”.

In this manner, information that may vary depending on the situation is set aside as parameter information in the user-specific page-definition file 16a. With this provision, the same component-information file 17 can be used for different users requesting different display contents as in the case where different folders are referred to.

The description 172 provides a file name (DocumentList.xsl) of the format-information file 18 that defines format information as the format-information acquiring method. As can be seen from the description 172, the format information is stored in a file having the file name “documentList.xsl”.

At step S15 following step S14, the divided-page module 12 acquires display information to be displayed in the current block according to the display-information acquiring method defined in the component-information file 17. If the current block is the center block, for example, the divided-page module 12 acquires a list of documents as the display information by calling a document-list acquiring method provided as an object in the data management server 20 by use of the RPC of SOAP according to the description 171 of FIG. 7. The divided-page module 12 specifies the values of respective parameters for the document-list acquiring method according to the description 1642a of the page-definition file 16a.

The source from which display information is acquired is not limited to the data management server 20. As long as a location such as the HDD 114 of the Web server 10 is accessible by the Web server 10 to acquire information, various locations may be specified by the display-information acquiring method as the source from which display information is acquired. For example, when display information is to be acquired from a predetermined file, it suffices to provide the file name of the predetermined file in the display-information acquiring method as in the case of the format-information acquiring method provided in the description 172 of FIG. 7.

At step S16 following step S15, the divided-page module 12 converts the acquired display information into XML-format data (hereinafter referred to as a display information XML), and merges the display information XML with a display-information template file for storing one divided page of display information in the XML format.

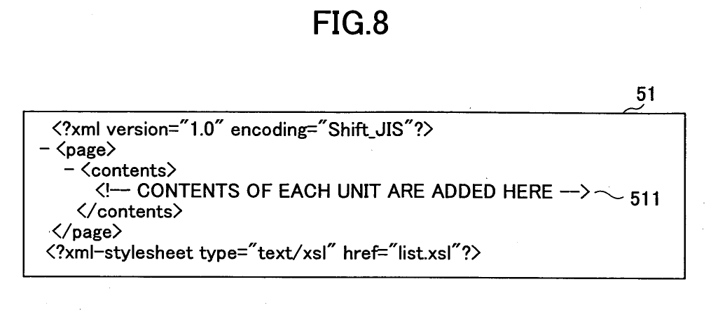

FIG. 8 is an illustrative drawing showing an example of the display-information template file. A display-information template file 51 is an XML-format file for consolidating display information XMLs acquired for respective blocks into one divided page of display information, and includes header information of the XML data in advance. In FIG. 8, display information XMLs for respective blocks are successively added to the portion indicated by reference numeral 511.

At step S17 following step S16, the divided-page module 12 acquires the format-information file 18 according to the format-information acquiring method defined in the component-information file 17 wherein the format-information file 18 defines the format of the relevant display component in the XSL format. If the current block is the center block, for example, the divided-page module 12 acquires a file having the file name “DocumentList.xsl” as the format-information file 18 of the current block according to the description 1712 of FIG. 7.

At step S18 following step S17, the divided-page module 12 merges the acquired format-information file 18 with a format-information template file 52 for storing one divided page of format information in the XSL format.

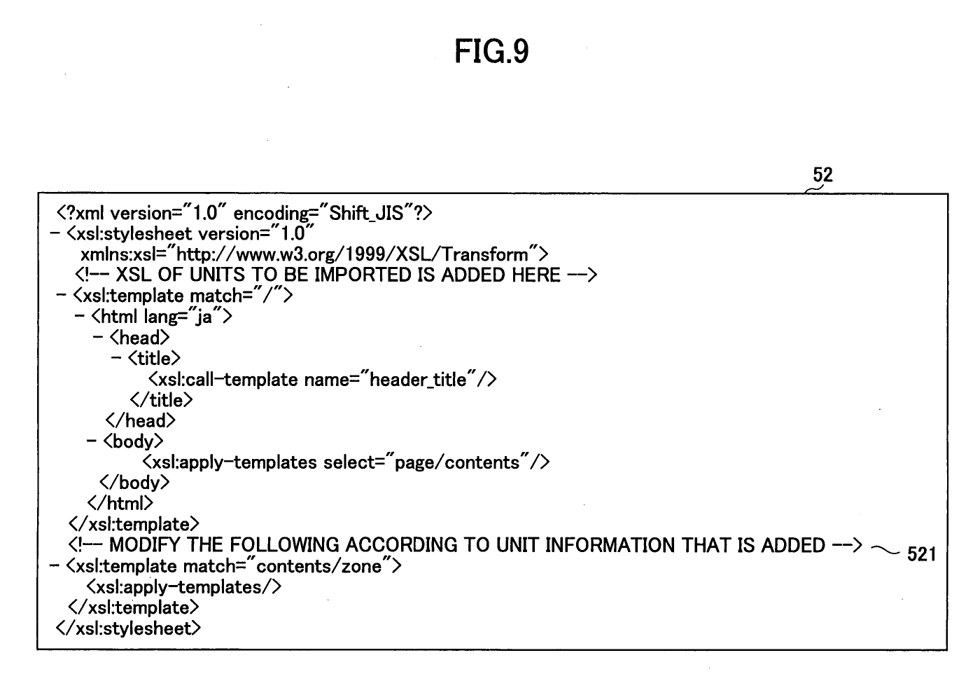

FIG. 9 is an illustrative drawing showing an example of the format-information template file. The format-information template file 52 is an XSL-format file for consolidating format information of the format-information files 18 acquired for respective blocks into one divided page of format information, and includes header information of the XSL data in advance. In FIG. 9, format information items for respective blocks are successively added to the portion indicated by reference numeral 521.

The procedure from step S14 to step S18 as described above is performed with respect to each of the blocks (top block, left block, center block, right block, and bottom block). As a result, the display-information template file 51 includes merged display information for all the blocks, and the format-information template file 52 includes merged format information for all the blocks (S19). Hereinafter, the display-information template file 51 including merged display information for all the blocks is referred to as a merged-display-information file. Also, the format-information template file 52 including merged format information for all the blocks is referred to as a merged-format-information file.

At step S20 following step S19, the XSLT processor 105 performs XSL conversion by applying the merged-format-information file to the merged-display-information file, thereby generating an HTML-format Web page, i.e., generating a divided page. When this is done, the divided page is generated in such a manner that one or more blocks to which no display component is assigned are merged with an adjacent block when appearing on the screen.

The divided page generated by the XSLT processor 105 is transmitted by the Web server program 101 to the client personal computer 31 for display by the Web browser 310 (S21).

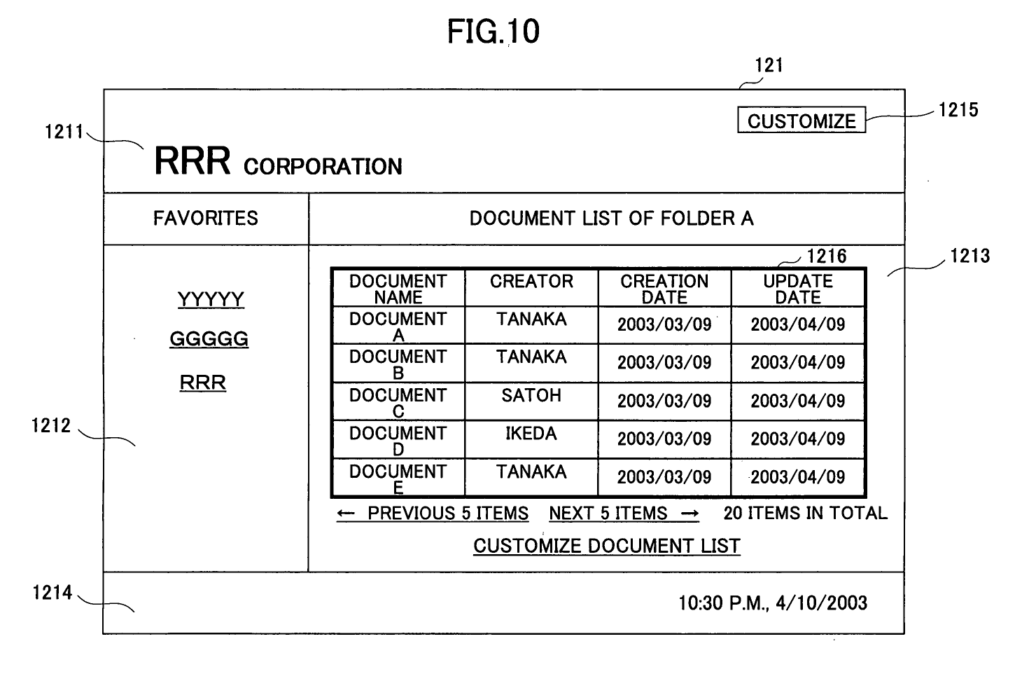

FIG. 10 is an illustrative drawing showing an example of how a divided page appears on the screen. A divided page 121 of FIG. 10 includes display components arranged for respective blocks in accordance with the definitions provided in the page-definition file 16 of FIG. 6. Namely, a top block 1211 includes a logo component (logo.xml), and a left block 1212 contains a bookmark component (bookmark.xml). Further, a center block 1213 presents a document-list component (documentlist.xml). Moreover, a bottom block 1214 has a calendar component (calendar.xml) arranged therein. Since no display component is associated with the right block, this block is merged with the adjacent center block 1213, resulting in the size of the center block 1213 being enlarged.

The format of a table 1216 for displaying a document list in the center block 1213, for example, is determined based on the format-information file 18 and the description 1642a of the page-definition file 16 (FIG. 6) corresponding to the center block 1213. Further, the document information shown in the table is acquired from the data management server 20 by the document-list acquiring method.

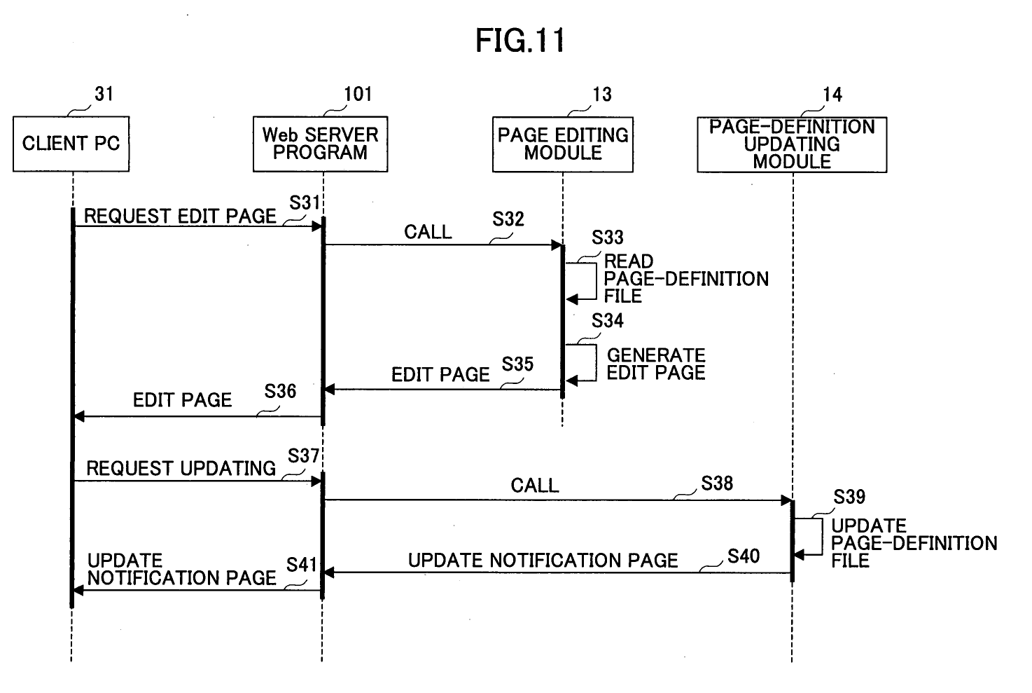

In the following, a description will be given of a process of letting a user select display components to be displayed in desired blocks of the divided page 121. FIG. 11 is a sequence chart showing a process performed by the Web server when display components to be displayed in desired blocks are modified.

On the divided page 121 shown in FIG. 10, the user of the client personal computer 31 clicks a customize button 1215, resulting in the Web browser 310 of the client personal computer 31 transmitting an HTTP request to the Web server 10 (S31), thereby requesting an edit page provided with a user interface for customizing the divided page 121. When the divided-page module 12 generates the divided page 121, the customize button 1215 may be provided at a predetermined location (at the top right corner of the top block in this embodiment) regardless of the definitions provided in the page-definition file 16. The customize button 1215 may be provided with a link to the edit page.

At step S32 following step S31, the Web server program 101 having received the HTTP request from the client personal computer 31 calls the page editing module 13 corresponding to the HTTP request.

At step S33 following step S32, the page editing module 13 reads the page-definition file 16a (FIG. 6) corresponding to the current user, and generates an edit page reflecting the current status of the page-definition file 16a (S34).

At step S35 following step S34, the page editing module 13 supplies the generated edit page to the Web server program 101. The Web server program 101 transmits the edit page to the client personal computer 31 for display by the Web browser 310 (S36).

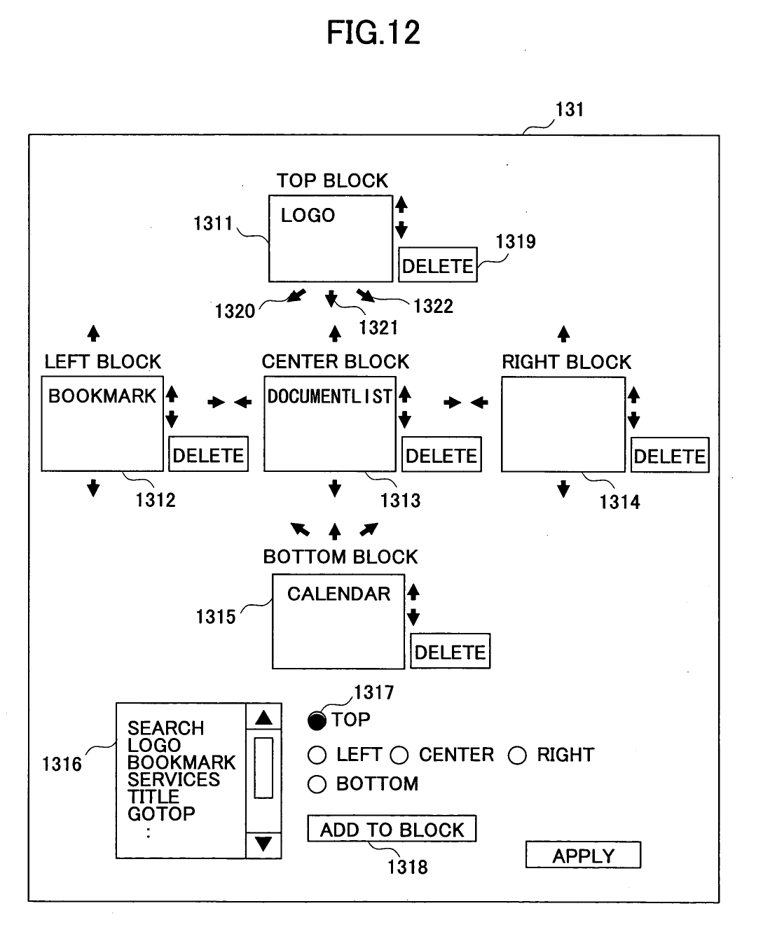

FIG. 12 is an illustrative drawing showing an example of an edit page. An edit page 131 shown in FIG. 12 has areas (hereinafter referred to as display-component setting areas) for which respective display components are selected on a block-specific basis, thereby associating the display components with the respective blocks of the divided page. Namely, a display-component setting area 1311 is provided for the top block, and display-component setting areas 1312, 1313, 1314, and 1315 are provided for the left block, the center block, the right block, and the bottom block, respectively.

At the bottom of the edit page 131, a display-component-list area 1316 for showing a list of all available display components is provided.

When a display component is desired to be added to the top block, for example, the name of the display component to be added is selected in the display-component-list area 1316. After checking a check bottom 1317 corresponding to the top block, an add button 131 is clicked to add the name of this display component in the display-component setting area 1311.

When a display component is desired to be deleted from the top block, for example, the name of the display component to be deleted is selected in the display-component setting area 1311. A delete button 1319 is then clicked to delete the name of this display component from the display-component setting area 1311.

When a display component is desired to be moved from the top block to another block, the name of the display component to be moved is selected in the display-component setting area 1311. A shift arrow 1320, 1321, or 1322 is then clicked to move the name of this display component to the display-component setting area 1312 (left block), the display-component setting area 1313 (center block), or the display-component setting area 1314 (right block).

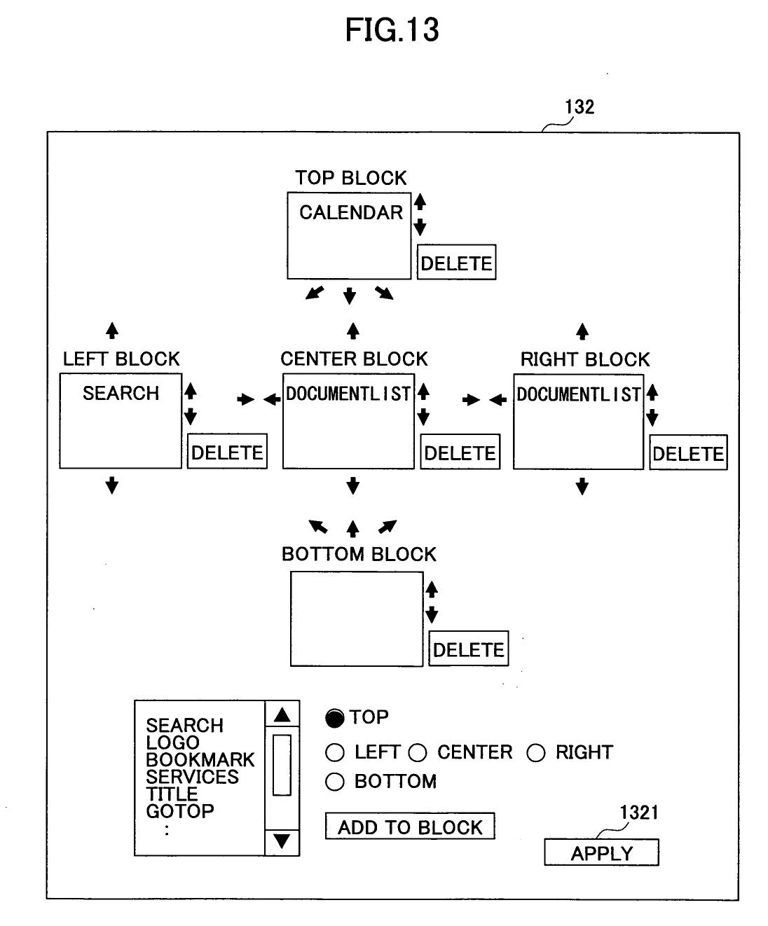

The same type of operation can be performed for the purpose of setting display components in other blocks. In this embodiment, such an operation suffices to update settings as shown in FIG. 13.

FIG. 13 is an illustrative drawing showing an example of the updated edit page. In an edit page 132 of FIG. 13, the top block is linked to a calendar component having the component name “calendar”. The left block is provided with a search component having the component name “search”, and the center block and the right block are each provided with a document-list component having the component name “documentlist”. It should be noted that the bottom block has no component assigned thereto. In comparison with FIG. 12, all the blocks except for the center block are modified.

In the edit page 132, a clock on an apply button 1321 results in the Web browser 310 transmitting an HTTP request to the Web server 10 (S37 in FIG. 11). This HTTP request requests the Web server 10 to update the correspondences of display components on the divided page (hereinafter referred to as divided-page updating). The HTTP request includes settings made on the edit page 132 as parameter information.

At step S38 following step S37, the Web server program 101 having received the HTTP request calls the page-definition updating module 14 corresponding to the HTTP request.

At step S39 following step S38, the page-definition updating module 14 updates the definitions of the modified blocks (all the blocks except for the center block in this example) in the definition of the page-definition file 16a corresponding to the current user. Such updating is done in accordance with the settings made on the edit page 132 that are contained in the parameter information of the HTTP request.

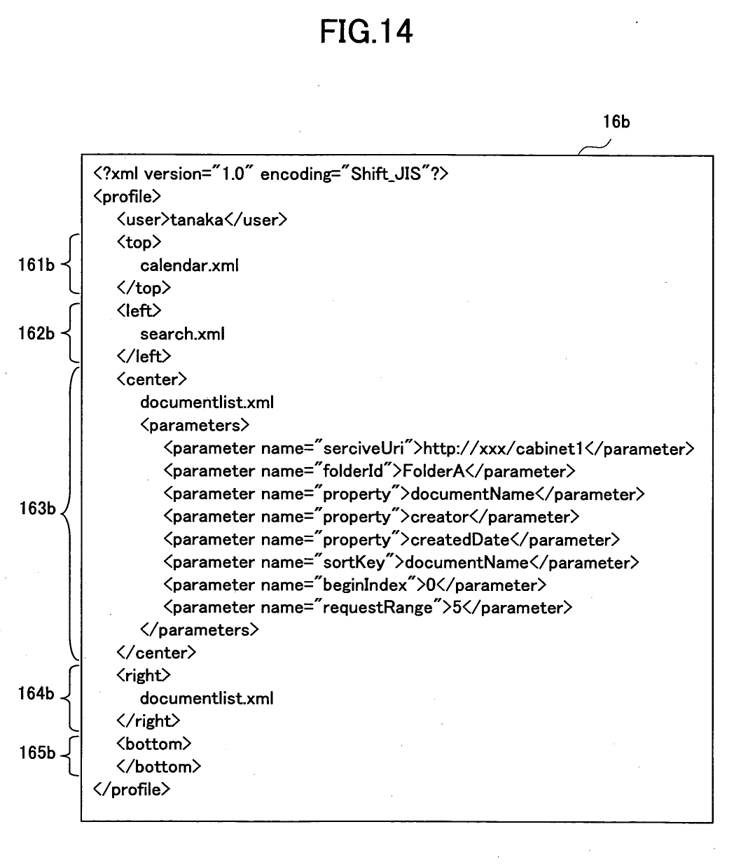

FIG. 14 is an illustrative drawing showing an example of the definition of an updated page-definition file. As shown in FIG. 14, the definition (description 161b) of the top block in an updated page-definition file 16b specifies the file name (calendar.xml) of a component information file corresponding to a calendar component. Further, the definitions of the left block (description 162b) and the right block (description 164b) specify the file name of component information files corresponding to a search component and a document-list component, respectively. Moreover, the definition of the bottom block has no component assigned thereto.

The definition (description 163b) of the unchanged center block stays the same as before (see the description 164a in FIG. 6).

At step S40 following step S39, the page-definition updating module 14 supplies a Web page to the Web server program 101 for informing of the updating of the divided page (e.g., a Web page for presenting a message “the divided page is updated”, which is hereinafter referred to as an updating notification page). The updating notification page is transmitted by the Web server program 101 to the client personal computer 31 for display by the Web browser 310 (S41). The user sees the updating notification page so as to learn that the updating of the divided page has been properly performed.

After the updating of the divided page, the user of the client personal computer 31 may enter the URL of the divided page by use of the Web browser 310 for the purpose of using the divided page again. In response, the Web server 10 performs the same processing as that described in connection with FIG. 4 based on the updated page-definition file 16b, thereby displaying the divided page through the Web browser 310.

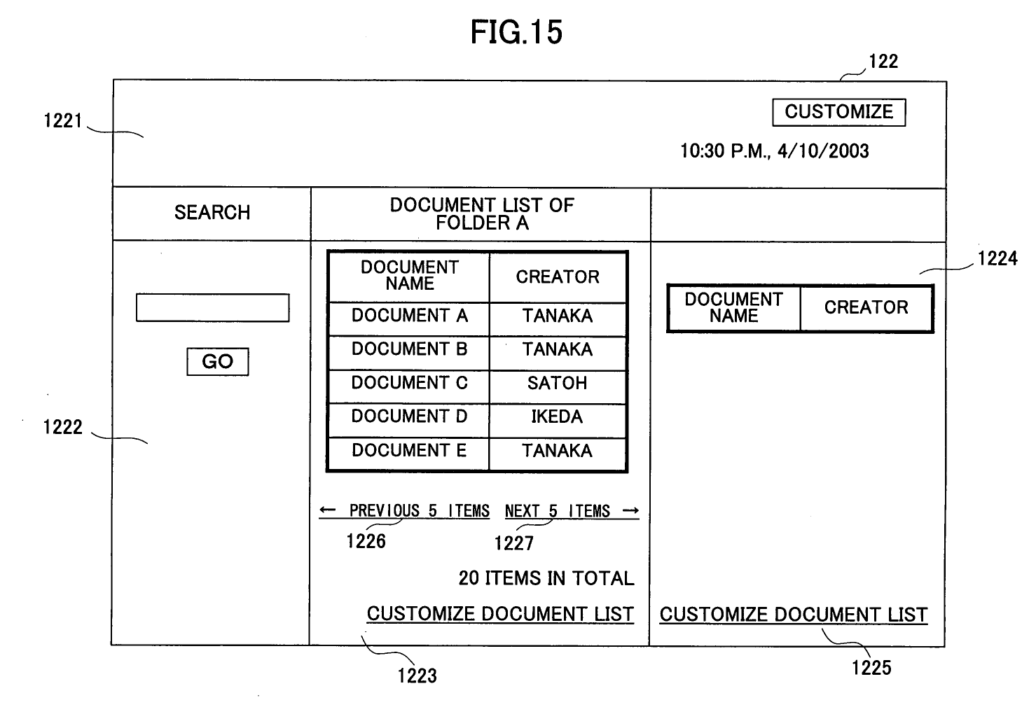

FIG. 15 is an illustrative drawing showing an example of an updated divided page. As shown in FIG. 15, a top block 1221 of an updated divided page 122 presents a calendar component, and a left block 1222 displays a search component. Further, a center block 1223 and a right block 1224 show document-list components, respectively.

The right block 1224 has no document list displayed therein. This is because the settings made on the edit page 132 do not specify a folder in which documents are searched for. In such a case, a default folder for search may be provided in advance, and a list of documents contained in the default folder may be displayed. Further, the bottom block has no display component assigned thereto, so that the area of the bottom block is merged with the adjacent left block 1222, center block 1223, and right block 1224, resulting in these areas being enlarged.

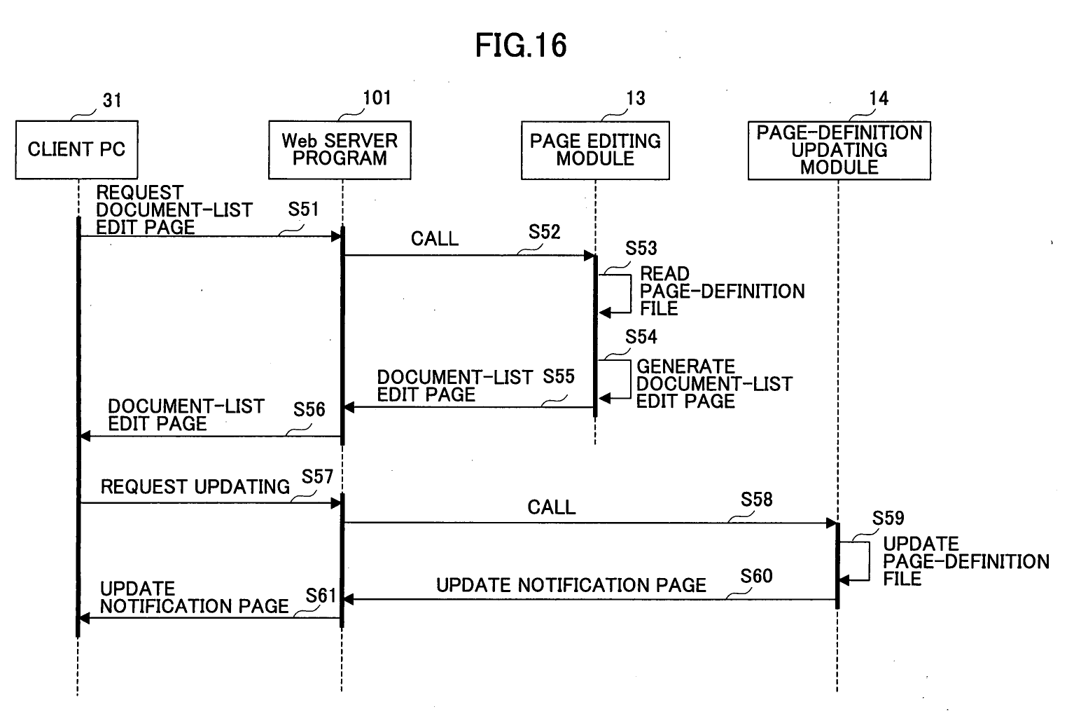

In the following, a description will be given of a case in which settings are made to a folder for document-list search and a display format of a document list such as a table format. FIG. 16 is a sequence diagram showing a process performed by the Web server when a setting is made with respect to the display format of a document list.

On the divided page 122 (FIG. 15), the user of the client personal computer 31 clicks a link 1225 (“customize the document list”), resulting in the Web browser 310 of the client personal computer 31 transmitting an HTTP request to the Web server 10 (S51). The HTTP request requests the transmission of a Web page (hereinafter referred to as a document-list editing page) having an interface for customizing the display format of the document list.

At step S52 following step S51, the Web server program 101 having received the HTTP request from the client personal computer 31 calls the page editing module 13 corresponding to the HTTP request.

At step S53 following the step S52, the page editing module 13 reads the page-definition file 16a (FIG. 6) corresponding to the current user, and generates a document-list editing page reflecting the current status of the page-definition file (S54).

At step S55 following step S54, the page editing module 13 supplies the generated document-list editing page to the Web server program 101. The Web server program 101 transmits the document-list editing page to the client personal computer 31 for display by the Web browser 310 (S56).

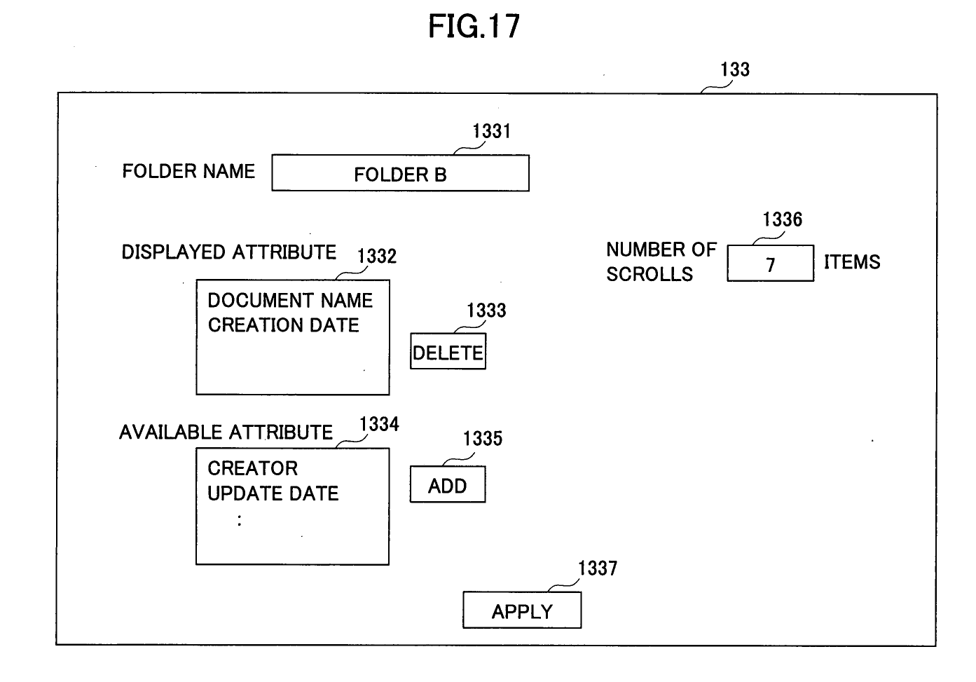

FIG. 17 is an example of a document-list editing page. A document-list editing page 133 shown in FIG. 17 includes a folder-name input field 1331, a display-attribute-list field 1332, a delete button 1333, a displayable-attribute-list field 1334, an add button 1335, a scroll-number input field 1336, and an apply button 1337.

The folder-name input field 1331 provides a field in which a folder name for document-list search is entered. In FIG. 17, a folder name is required to specify a folder for search. Alternatively, a tree component may be provided to allow a folder for search to be specified.

The display-attribute-list field 1332 presents a list of names of document attributes that are to be displayed in the document-list table.

The displayable-attribute-list field 1334 presents a list of names of document attributes that are not presently displayed but available for display in the document-list table.

If a certain document attribute is desired to be removed from the document-list table, for example, the name of this document attribute is selected in the display-attribute-list field 1332, followed by clicking the delete button 1333. This results in the selected attribute name moving to the displayable-attribute-list field 1334. If a certain document attribute is desired to be added to the document-list table, the name of this document attribute is selected in the displayable-attribute-list field 1334, followed by clicking the add button 1335. This results in the selected attribute name moving to the display-attribute-list field 1332.

The scroll-number input filed 1336 provides a field in which the amount of document-data shift responding to a click on a link 1226 or 1227 on the divided page 122 (FIG. 15) is specified by an input.

For example, a use may specify, on the document-list editing page 133, that a folder for search is “folder B”, that document attributes to be presented are “document name” and “creation date”, and that the number of scrolls is 7 items, followed by clicking the apply button 1337. In response, the Web browser 310 transmits an HTTP request to the Web server 10 to request the setting of the display format of a document list (S57 in FIG. 16). The HTTP request includes settings made on the document-list editing page 133 as parameter information.

At step S58 following step S57, the Web server program 101 having received the HTTP request calls the page-definition updating module 14 corresponding to the HTTP request.

At step S59 following step S58, the page-definition updating module 14 adds the settings made on the document-list editing page 133 as parameter information to the description 164b of the page-definition file 16b corresponding to the current user. As noted above, the parameter information is contained in the HTTP request.

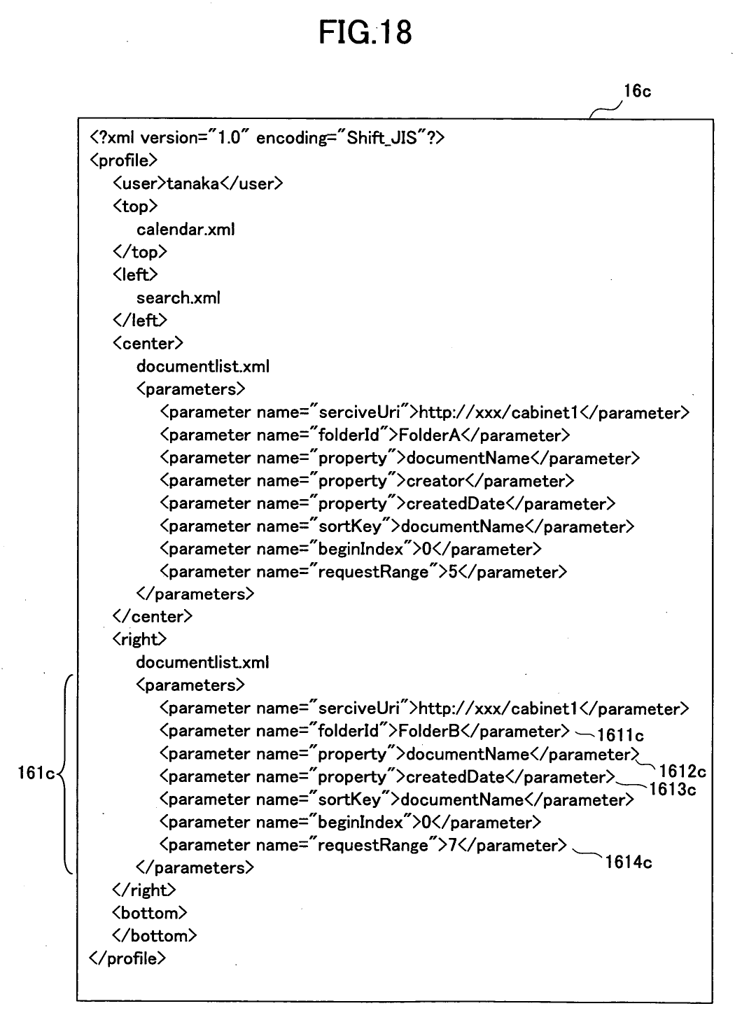

FIG. 18 is an illustrative drawing showing an example of the definition of a page-definition file to which parameter information is added. In a page-definition file 16c shown in FIG. 18, a description 161c is the newly added parameter information. That is, a description 1611c of the description 161c specifies the folder ID of the folder for search as “FolderB”, and descriptions 1612c and 1613c specify the document attributes to be displayed as “documentName” and “createdDate”, respectively. Further, a description 1614c specifies the number of scrolls as “7”.

At step S60 following step S59, the page-definition updating module 14 supplies an updating notification page to the Web server program 101. The updating notification page is transmitted by the Web server program 101 to the client personal computer 31 for display by the Web browser 310 (S61) The user sees the updating notification page so as to learn that the setting of the display format of a document list has been properly performed.

After the setting of the display format of a document list, the user of the client personal computer 31 may enter the URL of the divided page by use of the Web browser 310 for the purpose of using the divided page again. In response, the Web server 10 performs the same processing as that described in connection with FIG. 4 based on the updated page-definition file 16c, thereby displaying the divided page through the Web browser 310. Namely, when the divided-page module 12 calls a document-list acquiring method with respect to the right block, the parameter information given in the description 161c of the page-definition file 16c is used as parameter values.

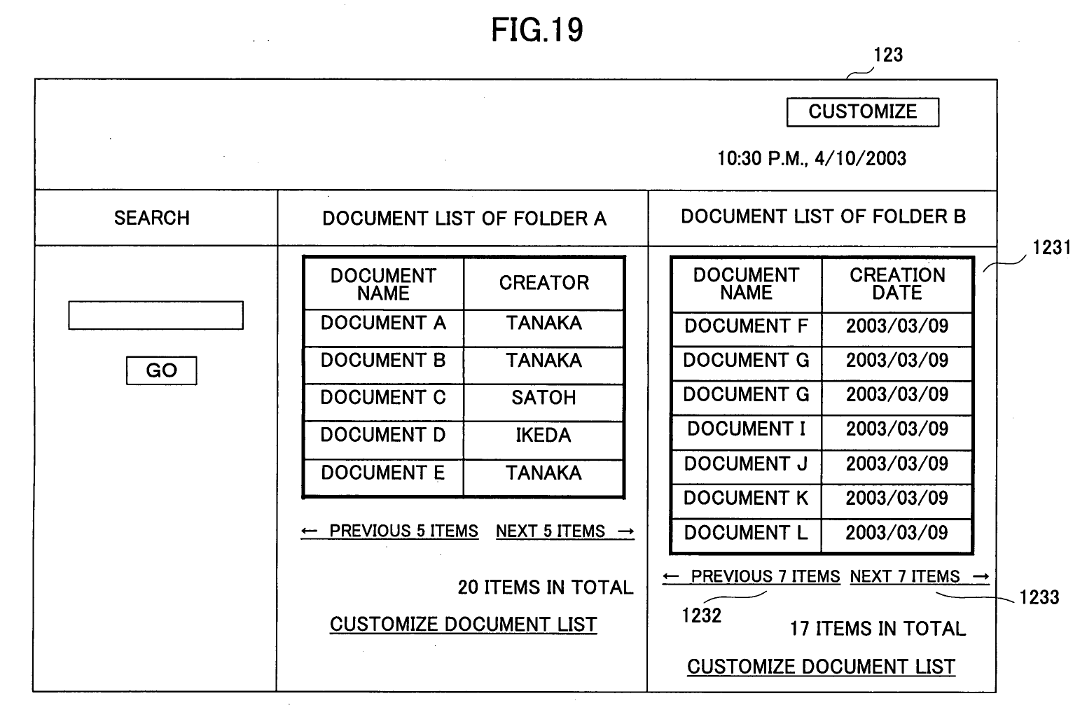

FIG. 19 is an illustrative drawing showing an example of a divided page after the setting of a document list is made for the right block. As shown in FIG. 19, an updated divided page 123 has a right block 1231 that shows a list of documents contained in the folder B.

Links 1232 and 1233 for scrolling the document list for display are shown as “7 previous items” and “7 next items”, respectively. That is, the number of scrolls is shown as 7 items as specified on the document-list editing page 133.

As described above, the Web server 10 according to the present embodiment allows a user to manipulate an edit page and to readily modify information displayed on the divided page. Accordingly, the user may choose desired display locations for desired information that is necessary for the user. The edit page is implemented as a Web page, so that a typical Web browser suffices to allow manipulation to be made on a terminal. There is no need for special software.

Objects displayed on the divided areas are provided as display components that are prearranged as components. Because of this, the definition of information displayed on each divided area is given by simply specifying a correspondence of a display component to a divided area. When display components displayed in the respective divided areas need to be changed according to settings made on the edit page, all that is necessary is to change the correspondences of the display components to the divided areas. Simple operation thus suffices to update the divided page.

The above description has been given with reference to an example in which the Web server 10 has the page-definition file 16. The page-definition file 16 is not necessarily provided in the Web server 10. For example, the page-definition file 16 may be located in the data management server 20 or in a server dedicated for controlling and managing the page-definition file 16.

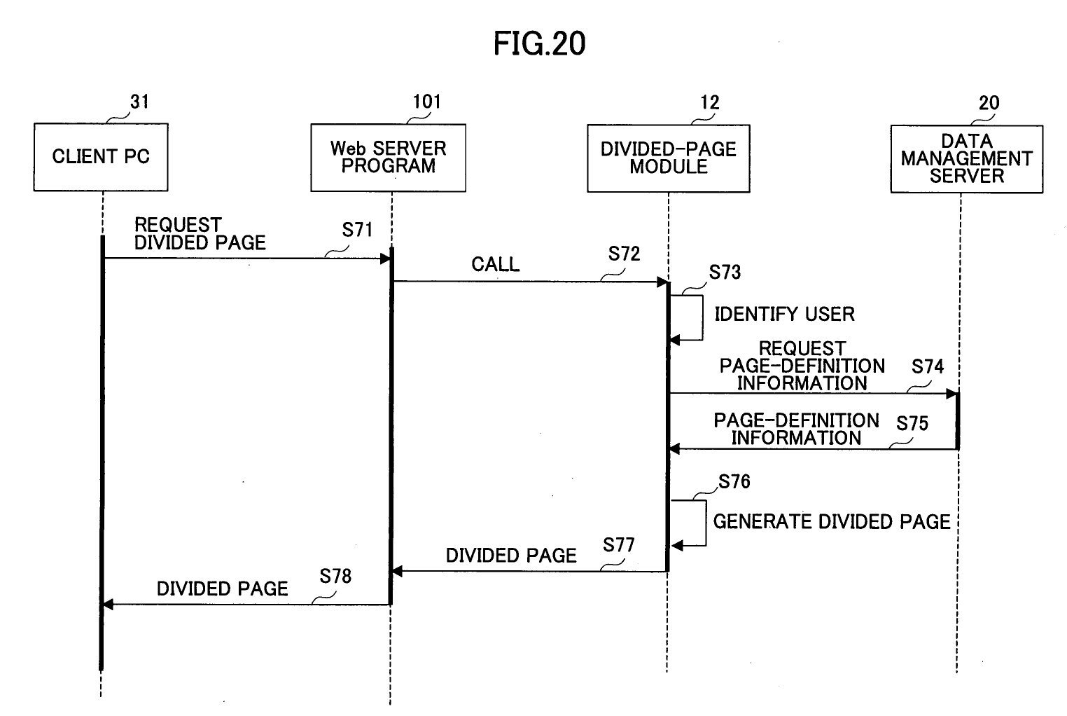

FIG. 20 is a sequence chart showing a divided-page generating process in the case where a page-definition file is managed by the data management server.

Steps S71 through S73 are the same as in the case where the Web server 10 possesses the page-definition file 16. Namely, in response to a request (HTTP request) from the client personal computer 31 to ask for the transmission of a divided page, the divided-page module 12 is called (S71, S72). The divided-page module 12 then identifies the user (current user) of the client personal computer 31 (S73).

At step S74 following step S73, the divided-page module 12 requests the data management server 20 to transmit page-definition information corresponding to the current user. At step S75 following step S74, the data management server 20 reads page-definition information from a page-definition file corresponding to the current user, and transmits the page-definition information to the Web server 10.

At step S76 following step S75, the divided-page module 12 having received the page-definition information generates a divided page by following the same procedure as described in steps S14 through S19 (FIG. 4) according to the page-definition information.

At and after step S77, the divided page generated by the divided-page module 12 is transmitted to the client personal computer 31 for display by the Web browser 310.

With the page-definition file 16 provided in the data management server 20 or the like, the page-definition file 16 can be shared by a plurality of Web servers when such Web servers are provided in the Web system and have functions similar to those of the Web server 10. This reduces the size of memory area required for the storage of the page-definition file 16. Further, the updating of a divided page updated through any one of the Web servers will be reflected in all the other Web servers. This improves user convenience.

In recent years, electronic apparatuses such as built-in devices specially made for specific functions have been equipped with the capability to perform information processing comparable to that of computers, and may be able to serve as a Web server. An example of such apparatus is a multifunction peripheral, which has multiple applications for performing specific functions required for combined services such as printing, copying, and faxing. Some image forming apparatuses of today are provided with a Web-server function, and may also be provided with a document-management function to store copied information or information received through fax as document data.

The function of the Web server 10 according to the embodiment of the invention may be provided in such an image forming apparatus. This provision makes it possible to easily modify the configuration of a screen displayed on the operation panel of the image forming apparatus.

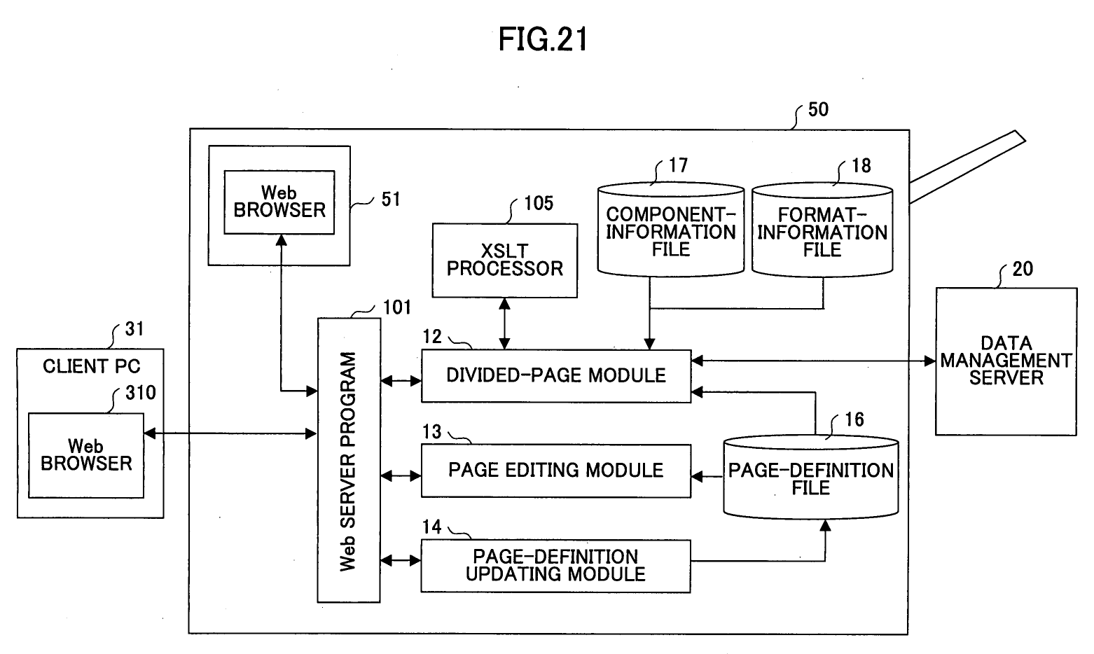

FIG. 21 is a block diagram showing an example of an image forming apparatus to which the Web server function according to the embodiment of the invention is applied. In FIG. 21, the same functional elements as those of FIG. 3 will be referred to by the same reference numbers, and a description thereof will be omitted. In FIG. 21, a portion 51 corresponds to an operation panel of an image forming apparatus 50 that receives user instruction indicative of copying, faxing, etc. The operation panel 51 has the function of a Web browser, for example, and allows a divided page generated by the divided-page module 12 and an edit page generated by the page editing module 13 to be displayed. A user manipulates the edit page on the operation panel 51, thereby easily modifying the configuration of a divided page and the configuration of a screen for receiving instruction for copying or the like.

The image forming apparatus 50 may also be able to provide a divided page and an edit page in response to a request from a Web browser located in another apparatus (e.g., the client personal computer 31 or another image forming apparatus). Such provision may be made by utilizing the Web server program 101 as in the case of the Web server 10.

Further, the present invention is applicable to other types of electronic apparatuses such as a mobile phone, a personal digital assistant, a microwave, a refrigerator, a washing machine, a television, a video recorder, an HDD recorder, an audio player, a digital camera, a router, a wireless LAN, a hub, and an automobile, as long as such apparatuses can accommodate a communication function.

In the embodiments described above, a Web page of an HTML format has been used as an example of display data. This is not intended to limit the data format of display data and communication with the client personal computer 31 to HTML and HTTP, respectively. The present invention is applicable to various data formats and protocols as long as they can be processed by the client personal computer 31.

Further, the present invention is not limited to these embodiments, but various variations and modifications may be made without departing from the scope of the present invention.

The present application is based on Japanese priority application No. 2003-203080 filed on Jul. 29, 2003, with the Japanese Patent Office, the entire contents of which are hereby incorporated by reference.

1. An apparatus for generating display data, which is supplied to a display apparatus connected through a network, and causes a screen comprised of a plurality of divided areas to be displayed, comprising:
an edit-screen providing unit configured to provide the display apparatus with edit-screen data that causes an edit screen to be displayed on which display components are selected for presentation in the respective divided areas; and
a display-data generating unit configured to generate the display data that causes display components selected on said edit screen to be displayed in the respective divided areas.

2. The apparatus as claimed in claim 1, further comprising:
a correspondence management unit configured to manage correspondences of the divided areas to the respective display components that are displayed in the divided areas; and
a correspondence updating unit configured to modify the correspondences managed by said correspondence management unit in response to settings made on said edit screen,
wherein said display-data generating unit generates the display data that causes the display components to be displayed in the respective divided areas according to the correspondences managed by said correspondence management unit.

3. The apparatus as claimed in claim 1, wherein said edit screen includes:
a plurality of display-component setting areas that allow names of the display components displayed in the respective divided areas to be selected on a divided-area-specific basis; and
a display-component-list area that displays names of all display components available for display,
wherein one or more names of one or more display components selected in said display-component-list area are moved to one or more of said plurality of display-component setting areas so as to select the display component displayed in the respective divided areas.

4. The apparatus as claimed in claim 3, wherein said edit screen allows the names of the display components to be moved between said display-component setting areas.

5. The apparatus as claimed in claim 3, wherein said edit screen allows the names of the display components to be deleted from the display-component setting areas.

6. The apparatus as claimed in claim 2, further comprising:
component-information management units each configured to keep definitions of a method of acquiring display information displayed by a display component and a method of acquiring format information about the display component, said component-information management units provided separately for respective types of the display components; and
a conversion unit configured to generate the display data by performing a predetermined conversion on the display information and the format information,
wherein said correspondence management unit manages correspondences of the divided areas to the respective component-information management units,
and wherein said display-data generating unit acquires the display information and the format information based on said correspondence management unit and said component-information management units, and causes said conversion unit to generate the display data based on the display information and the format information.

7. The apparatus as claimed in claim 6, wherein said display-data generating unit merges items of the display information and items of the format information acquired for the respective divided areas to generate a single item of merged display information and a single item of merged format information, and causes said conversion unit to generate the display data based on the merged display information and the merged format information.

8. The apparatus as claimed in claim 7, wherein the merged display information is XML-format data, and the merged format information is an XSL-format data, and wherein said conversion unit generates the display data by performing an XSL conversion based on the display information and the format information.

9. The apparatus as claimed in claim 6, wherein said component-information management units include interface information about the method of acquiring the display information, and said display-data generating unit calls the method according to the interface information to acquire the display information.

10. The apparatus as claimed in claim 9, wherein said correspondence management unit includes values of parameters that are used when calling the method.

11. The apparatus as claimed in claim 6, wherein each of said component-information management units includes a file name of a format-information file containing the format information as the method of acquiring the format information, and said display-data generating unit acquires the format information from a format-information file having said file name.

12. The apparatus as claimed in claim 2, wherein said correspondence management unit is provided for each user, and said display-data generating unit generates the display data based on a correspondence management unit corresponding to a user of said display apparatus, and wherein said correspondence updating unit updates the correspondences managed by the correspondence management unit corresponding to the user of said display apparatus.

13. The apparatus as claimed in claim 2, wherein the display data is divided into a top area, a middle area, and a bottom area, and said middle area is further divided into a left area, a center area, and a right area, and wherein said correspondence management unit manages the correspondences of the top area, the left area, the center area, the right area, and the bottom area to the respective display components.

14. The apparatus as claimed in claim 1, wherein said display-data generating unit generates the display data such that at least one of the divided areas having no selected display component is merged with one or more other divided areas when appearing on said display apparatus.

15. A display apparatus configured to be connected through a network to said apparatus for generating display data of claim 1, said display apparatus displaying the edit screen based on the edit-screen data received from said apparatus for generating display data.

16. The display apparatus as claimed in claim 15, transmitting a request to said apparatus for generating display data to demand a change in correspondences of the divided areas to the respective display components in response to settings made on the edit screen.

17. A system for generating display data, comprising:
a display apparatus; and
a display-data generating apparatus connected through a network to the display apparatus and configured to supply display data to the display apparatus to cause a screen comprised of a plurality of divided areas to be displayed,
wherein said display-data generating apparatus includes:
an edit-screen providing unit configured to provide the display apparatus with edit-screen data that causes an edit screen to be displayed on which display components are selected for presentation in the respective divided areas; and
a display-data generating unit configured to generate the display data that causes display components selected on said edit screen to be displayed in the respective divided areas,
and wherein said display apparatus includes a display unit configured to display a screen based on the display data and the edit-screen data supplied from the display-data generating apparatus.

18. The system as claimed in claim 17, wherein said display-data generating unit further includes:
a correspondence management unit configured to manage correspondences of the divided areas to the respective display components that are displayed in the divided areas; and
a correspondence updating unit configured to modify the correspondences managed by said correspondence management unit in response to settings made on said edit screen,
wherein said display-data generating unit generates the display data that causes the display components to be displayed in the respective divided areas according to the correspondences managed by said correspondence management unit.

19. The system as claimed in claim 18, further comprising:
component-information management units each configured to keep definitions of a method of acquiring display information displayed by a display component and a method of acquiring format information about the display component, said component-information management units provided separately for respective types of the display components; and
a conversion unit configured to generate the display data by performing a predetermined conversion on the display information and the format information,
wherein said correspondence management unit manages correspondences of the divided areas to the respective component-information management units,
and wherein said display-data generating unit acquires the display information and the format information based on said correspondence management unit and said component-information management units, and causes said conversion unit to generate the display data based on the display information and the format information.

20. The system as claimed in claim 19, further comprising an information management apparatus configured to manage predetermined information, wherein said display-data generating unit acquires the display information from said information management apparatus.

21. The system as claimed in claim 17, further comprising a management apparatus configured to manage correspondences of the divided areas to the respective display components that are displayed in the divided areas, wherein said display-data generating unit further includes a correspondence updating unit configured to modify the correspondences managed by said correspondence management unit in response to settings made on said edit screen, wherein said display-data generating unit generates the display data that causes the display components to be displayed in the respective divided areas according to the correspondences managed by said correspondence management unit.

22. A method of controlling an apparatus for generating display data which is supplied to a display apparatus connected through a network and causes a screen comprised of a plurality of divided areas to be displayed, comprising:
an edit-screen providing step of providing the display apparatus with edit-screen data that causes an edit screen to be displayed on which display components are selected for presentation in the respective divided areas; and
a display-data generating step of generating the display data that causes display components selected on said edit screen provided by said edit-screen providing step to be displayed in the respective divided areas.

23. The method as claimed in claim 22, wherein said edit screen includes:
a plurality of display-component setting areas that allow names of the display components displayed in the respective divided areas to be selected on a divided-area-specific basis; and
a display-component-list area that displays names of all display components available for display,
wherein one or more names of one or more display components selected in said display-component-list area are moved to one or more of said plurality of display-component setting areas so as to select the display component displayed in the respective divided areas.

24. A computer-readable record medium having a program embodied therein for causing a computer to generate display data, which is supplied to a display apparatus connected through a network and causes a screen comprised of a plurality of divided areas to be displayed, said program comprising:
an edit-screen providing step of providing the display apparatus with edit-screen data that causes an edit screen to be displayed on which display components are selected for presentation in the respective divided areas; and
a display-data generating step of generating the display data that causes display components selected on said edit screen provided by said edit-screen providing step to be displayed in the respective divided areas.

25. The program embodied in said computer-readable record medium of claim 24.

26. An electronic apparatus, comprising:
an operation panel configured to display a divided screen comprised of a plurality of divided areas;
an edit-screen displaying unit configured to cause said operation panel to display an edit screen on which display components are selected for presentation in the respective divided areas; and
a divided-screen generating unit configured to generate the divided screen on which display components selected on said edit screen are displayed in the respective divided areas.

27. The electronic apparatus as claimed in claim 26, further comprising:
a correspondence management unit configured to manage correspondences of the divided areas to the respective display components that are displayed in the divided areas; and
a correspondence updating unit configured to modify the correspondences managed by said correspondence management unit in response to settings made on said edit screen,
wherein said divided-screen generating unit generates the divided screen on which the display components are displayed in the respective divided areas according to the correspondences managed by said correspondence management unit.

28. A method of controlling an electronic apparatus, which has an operation panel on which a divided screen comprised of a plurality of divided areas is displayed, comprising:
an edit-screen displaying step of causing said operation panel to display an edit screen on which display components are selected for presentation in the respective divided areas; and
a divided-screen generating step of generating the divided screen on which display components selected on said edit screen at said edit-screen displaying step are displayed in the respective divided areas.
